(19) United States
(12) Patent Application Publication
(10) Pub. No.: US 2026/0135305 A1
(43) Pub. Date: May 14, 2026

(54) ELECTRICAL TERMINAL

(71) Applicant: TE Connectivity Solutions GmbH, Schaffhausen (CH)

(72) Inventors: Romain VILLARD, Saint Priest (FR); Geoffrey MOINE, Saint Priest (FR)

(21) Appl. No.: 19/384,456

(22) Filed: Nov. 10, 2025

(30) Foreign Application Priority Data
Nov. 11, 2024 (EP) 24212216.6

(51) Int. Cl. H01R 4/2429

(52) U.S. Cl. CPC H01R 4/2429

(57) ABSTRACT

An electrical terminal, in particular an IDC-terminal, with a housing, a contacting base positioned inside the housing and at least one actuating unit, wherein the contacting base comprises a contacting body with at least one blade-structure comprising at least one blade with at least one cutting edge, wherein the actuating unit is movable inside the housing along a contacting direction between a neutral position and a contacting position defined by a position of the blade-structure, wherein the actuating unit comprises a positioning face facing the blade-structure, wherein the housing defines an accommodation space between the positioning face of the actuating unit and the blade-structure of the contacting base, and wherein by moving the actuating unit from the neutral position to the contacting position a distance between the positioning face and the blade-structure is reducible.

### CROSS REFERENCE TO RELATED APPLICATIONS

This application claims the benefit of EP Application Serial No. 24212216.6, filed 11 Nov. 2024, the subject matter of which is herein incorporated by reference in its entirety.

### BACKGROUND OF THE INVENTION

The subject matter herein relates to an electrical terminal, in particular to an IDC-terminal.

Electrical terminals and in particular IDC-terminals are known from state of the art.

An objective of the subject matter herein is to provide an improved electrical terminal, an improved electrical terminal system and an improved method for assembling an electrical terminal system.

The objective is solved by the electrical terminal, the system and the method of the independent claims. Embodiments are subject of the dependent claims.

### BRIEF DESCRIPTION OF THE INVENTION

According to an aspect an electrical terminal, in particular an IDC-terminal, with a housing, a contacting base positioned inside the housing and at least one actuating unit is provided, wherein the contacting base comprises a contacting body with at least one blade-structure comprising at least one blade with at least one cutting edge, wherein the actuating unit is movable inside the housing along a contacting direction between a neutral position and a contacting position defined by a position of the blade-structure, wherein the actuating unit comprises a positioning face facing the blade-structure, wherein the housing defines an accommodation space between the positioning face of the actuating unit and the blade-structure of the contacting base, and wherein by moving the actuating unit from the neutral position to the contacting position a distance between the positioning face and the blade-structure is reducible.

This can achieve the technical advantage, that an improved electrical terminal can be provided that allows for IDC contacting of conductors. The electrical terminal comprises a contacting base with a blade-structure comprising at least one blade having a least one cutting edge and an actuating unit, that is movable between a neutral position and a contacting position. With the actuating unit positioned in the neutral position, a to be contacted conductor can be inserted into the housing and positioned in an accommodation space between the positioning face of the actuating unit and the blade-structure of the contacting base. By inserting the conductor into the housing, the conductor can be positioned adjacent to a positioning face of the actuating unit. By moving the actuating unit from the neutral position to the contacting position, a distance between the positioning face and the blade-structure can be reduced. This means, by moving the actuating unit from the neutral position to the contacting position the conductor inserted into the housing and positioned adjacent to the positioning face of the actuating unit is pushed from the neutral position to the contacting position. The contacting position is defined by a position of the blade-structure of the contacting base. Thus, by pushing the conductor from the neutral position to the contacting position via actuating the actuating unit, the conductor is pushed into the blade-structure as the distance between the positioning face of the actuating unit and the blade structure is reduced. This results in a cutting of the conductor insulation and a contacting of the conductor body of the conductor by the at least one blade of the blade-structure of the contacting base. This way, an IDC contacting of the conductor is realized. Thus, the electrical terminal provides an improved electrical terminal that is capable of providing an IDC contacting of conductors and that allows for an easy handling by a user. In order to execute the IDC contacting process, the user only has to insert the conductor with the actuating unit positioned in the neutral position and then push the actuating unit from the neutral position to the contacting position. The contacting of the conductor body of the conductor via the blade-structure of the contacting base is achieved automatically when the conductor is pushed to the contacting position by the actuation of the actuating unit. The contacting base further comprises a contacting body connected to the blade-structure. By contacting the contacting body to another electrical component, for example, to another conductor, the conductor contacted by the blade-structure by means of the IDC contacting can be contacted to this further electrical component.

The electrical terminal can be connected to a DIN rail.

In the application IDC stands for Insulation-Displacement-Contact.

According to an embodiment the blade-structure comprises a forklike structure with two blades and an opening facing the positioning face of the actuating unit, wherein each of the blades has a cutting edge, and wherein the cutting edges of the two blades are facing each other and/or are facing the positioning face of the actuating unit.

This can achieve the technical advantage that due to the forklike structure with two blades having cutting edges facing each other, the blade-structure of the contacting unit can provide a robust and efficient electrical contacting of the inserted conductor. By means of the two blades, the conductor inserted into the terminal is cut by each of the two blades when the contacting unit is positioned in the contacting position.

Thus, the conductor insulation is cut on two separate positions and the contacting body is contacted via each of the two blades of the blade-structure. This provides a robust and efficient electrical contacting.

According to an embodiment the two blades of the blade-structure are spaced apart from each other and arranged to provide a clamping force.

This can achieve the technical advantage that by means of the clamping force of the blade structure the conductor body can be held by the two blades of the blade-structure when the contacting unit is positioned in the contacting position. This leads to a robust electrical contacting of the conductor.

According to an embodiment a tip portion of the blade has a chamfered face.

This can achieve the technical advantage that via the chamfered faces of the tip portions of the blades, an easy cutting of the conductor insulation and easy contacting of the conductor by means of the blade-structure can be achieved.

According to an embodiment the terminal comprises two actuating units, wherein the contacting base comprises two blade-structures connected to each other via the contacting body of the contacting base.

This can achieve the technical advantage, that two individual conductors can be contacted electrically by means of the electrical terminal. For this, the electrical terminal comprises two actuating units and the contacting base comprises two blade-structures connected to each other via the contacting body. Each actuating unit and each blade-structure is therefore arranged to individually contact one of the two conductors. The contacting process for each of the conductors is identical to the above-described IDC contacting process and comprises the positioning of the respective conductor in the insertion position while the respective actuating unit is positioned in the neutral position and then to push the actuating unit from the neutral position to the contacting position. This way, the respective conductor is pushed into the respective blade-structure of the contacting base, which results in a cutting of the conductor insulation and a contacting of the conductor body via the respective blade-structure. This way, each of the two conductors is contacted by the respective blade-structure of the contacting base. As both blade-structures are connected via the contacting body, an electrical contacting between the two individual conductors by means of the blade-structures and the two blade-structures connecting contacting body of the contacting base is realized. Thus, the electrical terminal allows for an easy IDC contacting of multiple individual conductors.

According to an embodiment the contacting base has a platelike shape with the two blade-structures positioned on opposing ends of the contacting body.

This can achieve the technical advantage, that a contacting base can be provided, that is easy to manufacture. Further, the space requirement of the contacting base can be minimized, which also leads to a minimal space requirement of the entire electrical terminal.

According to an embodiment the actuating unit comprises an actuating member protruding from the housing, and wherein by means of the actuating member the actuating unit can be pushed from the neutral position to the contacting position.

This can achieve the technical advantage that by means of the actuating member protruding from the housing of the electrical terminal, the contacting unit can easily be moved from the neutral position to the contacting position via a user of the electrical terminal. As the actuating member is positioned outside the housing, the user only has to push the actuating member in contacting direction and by this push the contacting unit and the respective blade-structure from the neutral position to the contacting position. This allows for an easy handling of the electrical terminal and an easy way to contact conductors by means of the electrical terminal.

According to an embodiment the actuating unit is made of a plastic material, and/or wherein the contacting base comprising the blade-structure is made of a metal material by means of a punching process and bending process.

This can achieve the technical advantage that the contacting unit and the contacting base are easy to manufacture.

According to an embodiment the housing and/or the actuating unit comprise a releasing element arranged to release the actuating unit from the contacting position.

This can achieve the technical advantage that by means of the releasing elements, the contacting unit can be released from the contacting position and be reset to the neutral position. As the contacting unit is released from the contacting position, the blades of the blade-structure are released from the conductor positioned in the insertion position. Thus, the conductor can be removed from the terminal. As a result, the terminal can be reused for conducting a different conductor.

According to an embodiment the actuating unit is lockable in the neutral position and/or the contacting position by means of a snap connection between the actuating unit and the housing.

This can achieve the technical advantage that via the snap connection, a robust positioning of the contacting unit in the neutral position and/or in the contacting position can be achieved. By robustly positioning the contacting unit in the neutral position and/or the contacting position, the handling of the terminal is improved. In particular, by robustly locking the contacting unit in the contacting position via the snap connection, the robustness of the electrical contacting of the conductor is further enhanced.

According to an embodiment the housing comprises at least one insertion opening, wherein the insertion opening is elongated along the contacting direction, and/or wherein the actuating unit comprises an insertion stop arranged to terminate the positioning face at a closed end opposite to the insertion opening.

This can achieve the technical advantage, that via the elongated insertion opening the conductor inserted into the housing when the respective actuating unit is positioned in the neutral position can be moved to the contacting position by moving the actuating unit from the neutral position to the contacting position. By moving the actuating unit from the neutral position to the contacting position, the conductor is also pushed to the contacting position and into the blade-structure of the contacting base to contact the conductor by means of cutting the conductor insulation via the cutting edges of the blades of the blade-structure. To allow the movement of the conductor from the neutral position to the contacting position, the insertion opening of the housing is elongated along the contacting direction which corresponds to the movement path of both the actuating unit and the conductor.

According to an embodiment the contacting base is positioned in the housing by means of a clip connection.

This can achieve the technical advantage, that an easy and fast assembly of the electrical terminal is possible. Also, the contacting base can be removed from the housing if necessary.

According to an aspect a terminal system with an electrical terminal according to any of the preceding embodiments and at least one conductor is provided, wherein the at least one conductor is inserted into the housing and positioned in the contacting position, wherein the actuating unit is positioned in the contacting position, wherein the conductor insulation of the conductor is cut and the conductor body of the conductor is contacted by the at least one cutting edge of the at least one edge of the blade-structure of the contacting base, and wherein an electrical contact between the conductor body of the conductor and the contacting base is provided by means of the at least one blade of the blade-structure.

This can achieve the technical advantage that an improved terminal system with an electrical terminal with the abovementioned technical advantages can be provided.

According to an embodiment a further conductor is inserted into the housing of the terminal and positioned in the contacting position, wherein the further actuating unit is positioned in the contacting position, wherein the insulation of the further conductor is cut and the conductor body of the further conductor is contacted by the at least one cutting edge of the at least one blade of the further blade-structure of the contacting base, wherein an electrical contact between the conductor body of the further conductor and the contacting base is provided by means of the at least one blade of the blade-structure of the further blade-structure, and wherein an electrical contact between the conductor and the further conductor is provided by means of the contacting base.

This can achieve the technical advantage that via the terminal system two individual conductors can be contacted to each other by means of the electrical terminal.

According to an aspect a method of assembling a terminal system is provided, comprising:
Providing an electrical terminal according to any of the preceding embodiments and at least one conductor;
Positioning the at least one actuating unit of the terminal in the neutral position;
Inserting the at least one conductor into the housing of the electric terminal and positioning an end portion of the conductor adjacent to the contacting base of the terminal; and
Pushing the at least one actuating unit from the neutral position to the contacting position, wherein in the contacting position the insulation of the conductor is cut by the at least one cutting edge of the at least one blade of the blade-structure of the contacting base and the conductor body of the at least one conductor is contacted by the cutting edge of the blade of the blade-structure.

This can achieve the technical advantage that an improved method for electrically contacting individual conductors by means of IDC-contacting can be achieved.

### BRIEF DESCRIPTION OF THE DRAWINGS

The invention is described with respect to the figures. In the figures it is illustrated in:

FIG. 1 a schematic illustration of an electrical terminal system with an electrical terminal according to an embodiment,

FIG. 2 another schematic illustration of the electrical terminal system with an electrical terminal according to another embodiment,

FIG. 3 a schematic sectional view of the electrical terminal according to an embodiment,

FIG. 4 a schematic illustration of actuating units and a conducting base of the electrical terminal according to another embodiment,

FIG. 5 a schematic illustration of the conducting base of the electrical terminal according to an embodiment,

FIG. 6 another schematic illustration of the conducting base of the electrical terminal according to an embodiment,

FIG. 7 schematic illustrations of the actuating units of the electrical terminal according to an embodiment, and

FIG. 8 a schematic sectional view of the housing of the electrical terminal according to another embodiment.

### DETAILED DESCRIPTION OF THE INVENTION

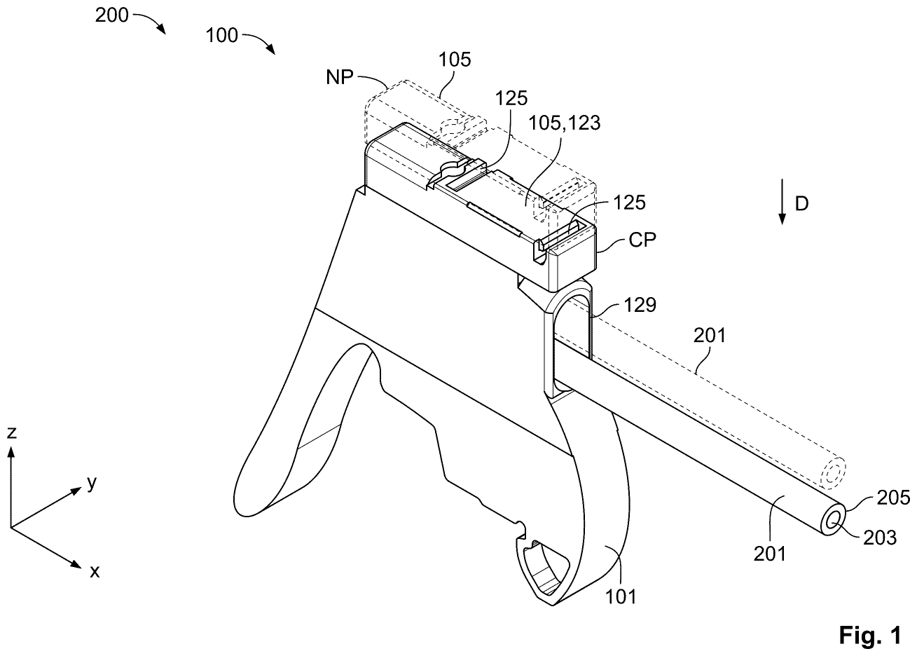

FIG. 1 shows a schematic illustration of an electrical terminal system 200 with an electrical terminal 100 according to an embodiment.

In the shown embodiment, the electrical terminal 100 comprises a housing 101, a contacting base 103 with a blade-structure 109, both in FIG. 1 not shown, and an actuating unit 105. The contacting base 103 is positioned inside the housing 101 and comprises the blade-structure 109 with at least one blade 111 having at least one cutting edge 113. Via the cutting edge 113 of the at least one blade 111, the blade-structure 109 of the contacting base 103 is arranged to cut a conductor insulation 205 of a conductor 201 inserted into the housing 101 of the electrical terminal 100, when the conductor 201 is positioned in a contacting position CP.

The electrical terminal 100 further comprises an actuating unit 105. The actuating unit 105 is movable relative to the housing 101 between a neutral position NP and a contacting position CP. In FIG. 1, the actuating unit 105 is shown positioned in the contacting position CP. In dashed lines, the actuating unit 105 is further illustrated in the neutral position NP.

The electrical terminal 100 is arranged to provide an IDC contacting of a conductor 201. In order to execute the IDC contacting of the conductor 201, the conductor 201 can be inserted into the housing 101 of the terminal 100 via an insertion opening 129, when the actuating unit 105 is positioned in the neutral position NP. The conductor 201 inserted into the housing 101 when the actuating unit 105 is positioned in the neutral position NP is illustrated in dashed lines.

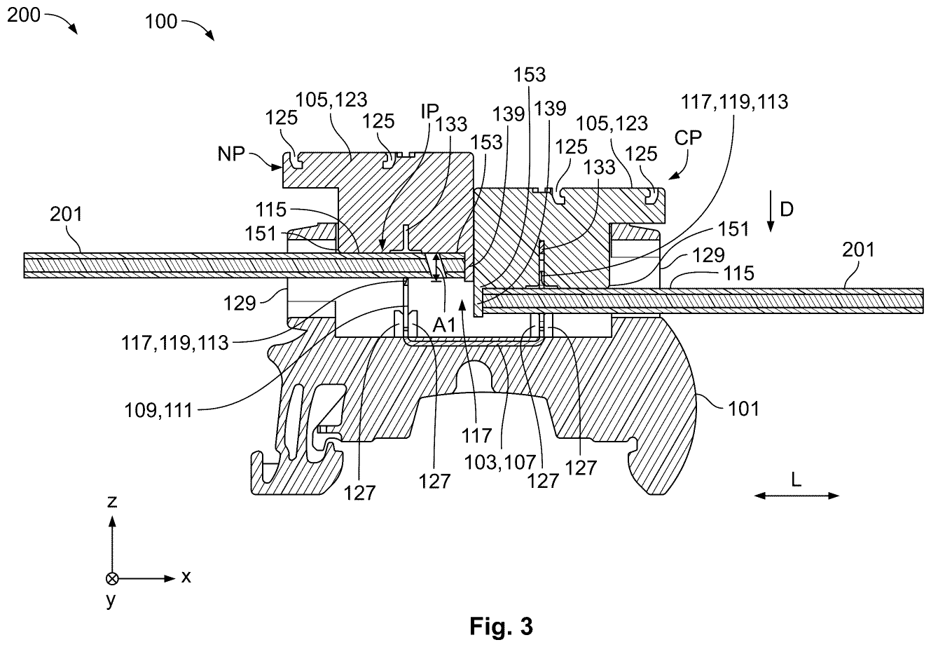

Now, by pushing the actuating unit 105 from the neutral position NP to the contacting position CP, the conductor 201 inserted into the housing 101 is pushed to the contacting position CP and by this is pushed into the blade-structure 109 of the contacting base 103 positioned inside the housing 101. For a more detailed description of the contacting mechanism, it is referred to the description related to the FIGS. 3 to 8.

In the shown embodiment, the actuating unit 105 comprises an actuating member 123, that is positioned outside the housing 101. In order to perform the contacting process, a user is capable of actuating the actuating unit 105 by grabbing the actuating member 123 positioned outside the housing 101 and pushing the actuating unit 105 from the neutral position NP to the contacting position CP.

In the shown embodiment, the insertion opening 129 is elongated along the contacting direction D. This allows the inserted conductor 201 to be moved from the neutral position NP to the contacting position CP by the actuating of the actuating unit 105.

In the shown embodiment, the actuating unit 105 further comprises marker housing elements 125 to mark and/or identify an electrical contact of a to be contacted wire.

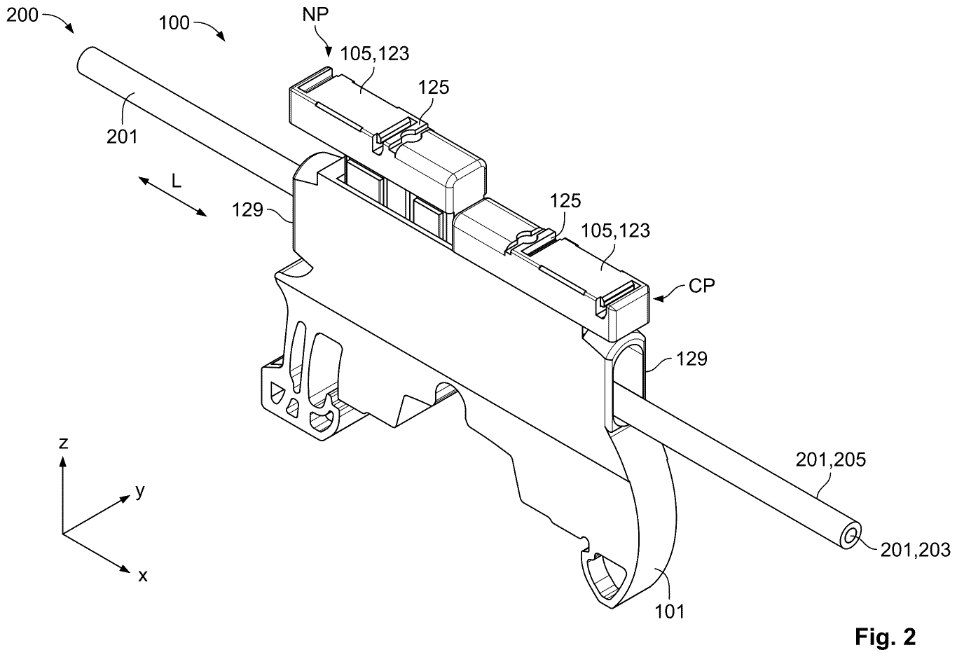

FIG. 2 shows another schematic illustration of the electrical terminal system 200 with an electrical terminal 100 according to another embodiment.

In the shown embodiment, the terminal 100 comprises two actuating units 105. In this embodiment, the contacting base 103, not shown in FIG. 2, also comprises two blade-structures 109. The housing 101 also comprises two insertion openings 129.

Via the two insertion openings 129, two individual conductors 201 can be inserted into the housing 101. Each of the actuating units 105 is arranged movable between the neutral position NP and the contacting position CP. By moving each of the actuating units 105 from the neutral position NP to the contacting position CP, the respective actuating unit 105 pushes the respective conductor 201 in direction of the respective blade-structure 109. Each of the two blade-structures 109 of the contacting base 103 is arranged to cut the conductor insulation 205 of the conductor 201 positioned in the contacting position CP and to contact the respective conductor body 203 via the respective blade 111.

In the shown embodiment, the two actuating units 105 and the two insertion openings 129 are positioned on opposite sides of the housing 101 with regard to a longitudinal direction L of the terminal 100.

FIG. 3 shows a schematic sectional view of the electrical terminal 100 according to an embodiment.

FIG. 3 illustrates a sectional view along the longitudinal direction L of the terminal 100 according to the embodiment of FIG. 2.

Shown from FIG. 3 is the internal of the housing 101. Inside the housing 101 between a positioning face 115 of the actuating unit 105 and the blade-structure 109 of the contacting base 103. In the shown embodiment the contacting base 103 comprises two blade-structures 109, each for one of the two actuating units 105.

The contacting base 103 further comprises a contacting body 107 extending along the longitudinal direction L of the housing 101. On opposite ends of the contacting body 107, the two blade-structures 109 are formed. Each blade-structure 109 comprises at least one blade 111. The at least one blade 111 extends along the contacting direction D perpendicular to the longitudinal direction L facing the positioning face 115 of the respective actuating unit 105. Each of the blades 111 comprises a tip portion 119 with a chamfered face 121 and at least one cutting edge 113.

As already mentioned, each of the two actuating units 105 comprises a positioning face 115. The positioning face 115 is arranged opposite to the actuating member 123 positioned outside the housing 101 and is parallel to the longitudinal direction L of the housing 101. As can be seen from FIG. 3, when the actuating unit 105 is positioned in the neutral position NP, the actuating unit 105 and in particular the positioning face 115 is distanced to the respective tip portion 119 of the respective blade-structure 109 by a distance A. This allows the conductor 201 to be inserted into the housing 101 and positioned in an insertion position IP, in which the respective conductor 201 contacts the positioning face 115 of the respective actuating unit 105 positioned in the neutral position NP.

Each positioning face 115 comprises an open end 151 located adjacent to the insertion opening 129 of the housing 101 and a closed end 153 positioned opposite to the open end 151 with regard to the longitudinal direction L. At the closed end 153, each actuating unit 105 comprises an insertion stop 131. The insertion stop 131 has a wall-like shape and stops the insertion of the conductor 201 in longitudinal direction L along the positioning face 115 of the respective actuating unit 105.

The insertion position IP of the conductor 201 thus is defined by the conductor 201 being positioned contacting the positioning face 115 and the insertion stop 131 of the respective actuating unit 105 positioned in the neutral position NP.

By pushing the actuating unit 105 from the neutral position NP to the contacting position CP, the distance A between the positioning face 115 and the blade structure 109 is reduced. The distance A can be defined between the positioning face 115 and the tip portions 119 of the blades 111 of the blade structure 109.

In the contacting position CP the distance A can be reduced to zero as the positioning face 115 of the respective actuating unit 105 can contact the blade-structure 109.

By moving the actuating unit 105 from the neutral position NP to the contacting position CP the respective conductor 201 positioned in the insertion position IP contacting the positioning face 115 and the insertion stop 131 of the respective actuating unit 105 is pushed to the contacting position CP and pushed into the blade-structure 109 extending from the contacting body 107 of the contacting base 103 in opposite of the contacting direction D.

By pushing the conductor 201 into the blade-structure 109, the conductor insulation 205 is cut by the at least one cutting edge 113 of the at least one blade 111 of the blade-structure 109. By cutting the conductor insulation 205, the respective blade 111 of the blade-structure 109 also contacts the conductor body 203 of the respective conductor 201.

Thus, by pushing both actuating units 105 and the respective conductors 201 to the contacting position CP, both conductor bodies 203 of both conductors 201 are contacted by the respective blade-structures 109. Since both blade-structures 109 are connected to each other via the contacting body 107 of the contacting base 103, an electrical contacting between both individual conductors 201 is achieved by means of the blade-structure 109 and the contacting body 107 of the contacting base 103.

In the shown embodiment, each of the actuating units 105 further comprises an insertion recess 133, respectively. The insertion recess 133 is slit-shaped and positioned at the positioning face 115 of the actuating unit 105. Each insertion recess 133 extends from the positioning face 115 in opposite contacting direction D. The insertion recess 133 is arranged to accommodate the respective blade-structure 109 of the contacting base 103 at least partially, when the respective actuating unit 105 is positioned in the contacting position CP.

In the shown embodiment, the housing 101 further comprises a snap connection 127. Via the snap connection 127, the contacting base 103 comprising the contacting body 107 and the blade-structures 109 can be fixated in the accommodation space 117 of the housing 101 by means of a snap connection 127.

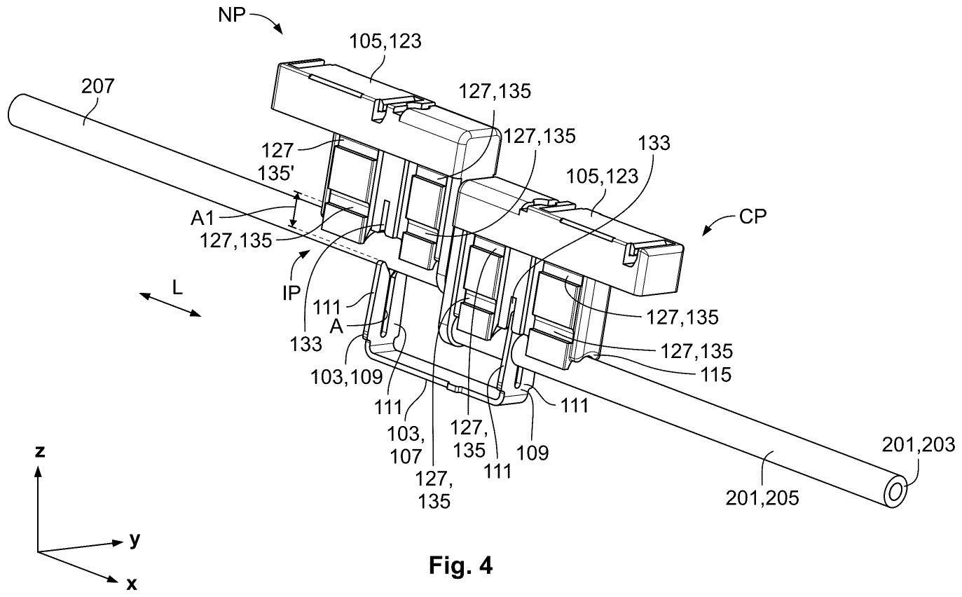

FIG. 4 shows a schematic illustration of actuating units 105 and a conducting base 103 of the electrical terminal 100 according to another embodiment.

The shown embodiment is based on the embodiment in FIG. 3 and comprises all features shown in FIG. 3.

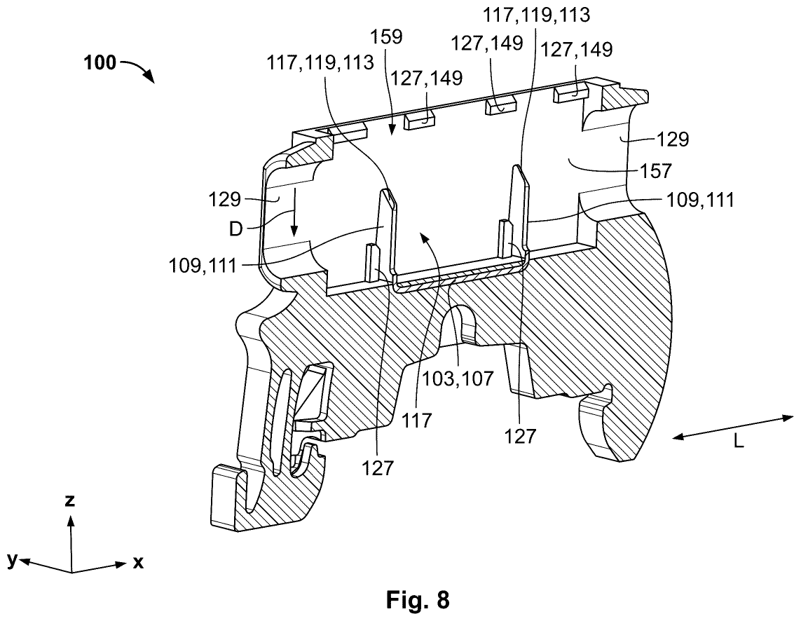

In the shown embodiment, each of the actuating units 105 comprises two parallel snap in grooves 135. Via the snap in grooves 135, the respective actuating unit 105 can be locked in the neutral position NP or the contacting position CP with respect to the housing 101 by means of a snap connection 127. In order to execute the snap connection 127, the housing 101 comprises respective snap in protrusions 149, illustrated in FIG. 8. The snap-in grooves 135 are extended along the longitudinal direction L and distanced to each other along the contacting direction D.

In the shown embodiment, each of the two blade-structures 109 of the contacting base 103 has a forklike shape having two individual blades 111 distanced to each other via a distance and define a space 139 between the blades 111.

In the shown embodiment, the positioning face 115 of the actuating units 105 each comprises a curved shape. Via the curved shape, the circular conductors 201 can be positioned more precisely in the insertion position IP via the positioning faces 115 of the respective actuating units 105.

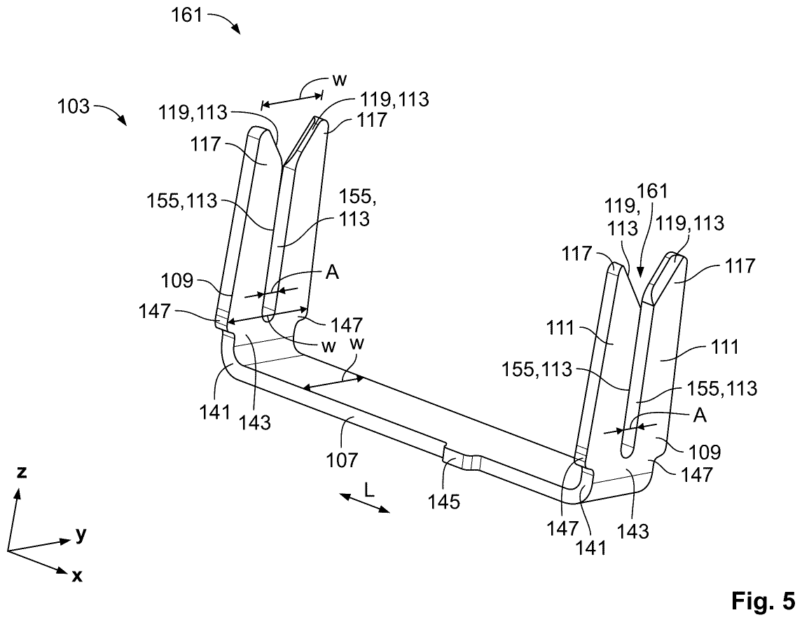

FIG. 5 shows a schematic illustration of the conducting base 103 of the electrical terminal 100 according to an embodiment.

The shown embodiment of the contacting base 103 corresponds to the embodiment shown in FIG. 4.

As illustrated, the contacting base 103 comprises a platelike shaped contacting body 107 with two blade-structures 109 positioned on opposing ends of the platelike shaped contacting body 107.

In the shown embodiment, the blade-structures 109 each have a forklike shape comprising two individual blades 111 distanced to each other and define the space 139 between the blades 111 to accommodate the conductor 201. The blade-structures 109 each comprise a base portion connected to the contacting body 107 via a bending portion 141. From each base portion 143, the two blade-structures 109 extend in a perpendicular direction to the longitudinal direction L. The extension directions of the blades 111 of the blade-structures 109 are parallel to each other and to the contacting direction D of the terminal 100.

Each of the blades 111 comprises a tip portion 119 opposite to the base portion 143. The tip portion 119 comprises a chamfered face 121 with a cutting edge 113.

The tip portions 119 define an opening 139 of the blade-structure 109 by means of which the conductor can be pushed into the blade-structure 109 and into the space 139 between the two blades 111. Due to the distance between the two blades 111 the blades 111 are arranged to generate a clamping force in direction of the respective other blade 111 and clamp the conductor 201 inserted into

In the shown embodiment, each of the blades 111 further comprises a cutting edge 113 at an inner edge 155. The inner edges 155 of the two parallel blades 111 of the same blade-structure 109 face each other and are separated from each other by means of the space 139.

In the shown embodiment, the base portion 143 of the respective blade-structures 109 further comprises a widened section 147. The widened sections 147 comprise a greater width W than the contacting body 107 of the contacting base 103 and/or a greater width W than the blade-structures 109 at the tip portions 119 of the respective blades 111. Via the widened section 147, the robustness of the blade-structures 109 can be improved and the clamping force provided by the blades 111 to a conductor body 203 inserted into a blade-structure 109 and positioned between two blades 111 of the same blade-structure 109 can be enhanced.

In the shown embodiment, the contacting body 107 of the contacting base 103 further comprises a mounting protrusion 145. Via the mounting protrusion 145, the contacting base 103 can be mounted to the housing 101 and fixated to the housing 101 via the snap connection 127.

According to an embodiment, the contacting base 103 comprising the contacting body 107 and the two blade-structures 109 are manufactured of a metal material by means of punching processes and/or bending processes.

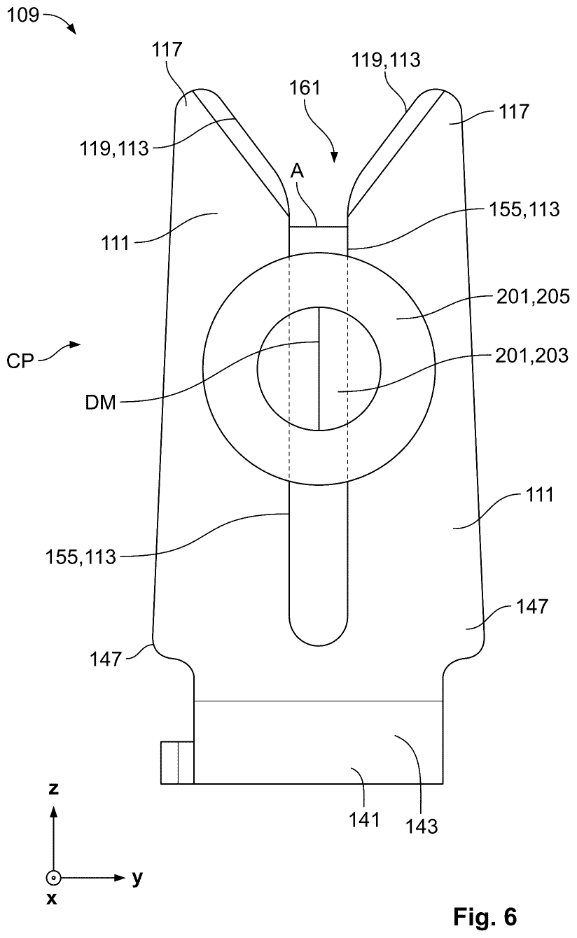

FIG. 6 shows another schematic illustration of the conducting base 103 of the electrical terminal 100 according to an embodiment.

FIG. 6 shows a frontal view along the longitudinal direction L of the contacting base 103 comprising the contacting body 107 and the blade-structures 109. In FIG. 6, a conductor 201 is pushed into the space 139 between the blades 111 of the illustrated blade-structure 109 via the opening 139 and is positioned between the two parallel blades 111. By pushing the conductor 201 into the space 139 of the blade-structure 109, the conductor insulation 205 is cut by the cutting edges 113 positioned at the chamfered faces 121 of the tip portions 119 and/or at the inner edges 155. As shown in FIG. 6, a diameter DM of the conductor body 203 is slightly larger than the distance between the inner edges 155 of the two separated blades 111. As a result, by pushing the conductor 201 into the blade-structure 109, the cutting edges 113 not only cut the conductor insulation 205 but also partially cut the conductor body 203 of the respective conductor 201. This leads to an improved electrical contacting between the conductor body 203 and the blade-structure 109 of the contacting base 103.

The shown conductor 201 is positioned in the contacting position CP, into which the conductor 201 was moved by the movement of the respective actuating unit 105 from the neutral position NP into the contacting position CP. For a better illustration, the respective actuating unit 105 is not illustrated in FIG. 6.

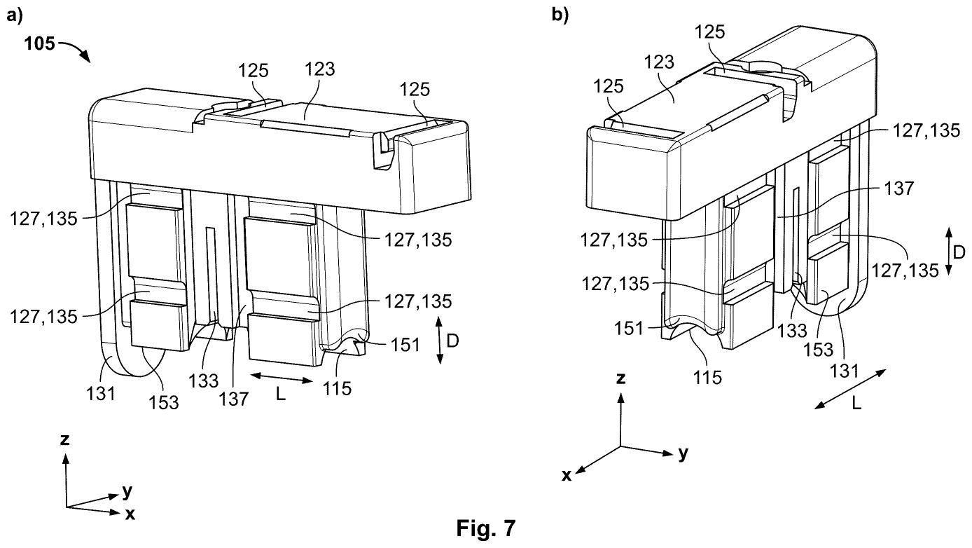

FIG. 7 shows schematic illustrations of the actuating units 105 of the electrical terminal 100 according to an embodiment.

Graphics a) and b) show the actuating unit 105 in two different perspectives.

The shown embodiment corresponds to the embodiment of the actuating units 105 shown in FIG. 4.

In the shown embodiment, the actuating units 105 further comprise guiding grooves 137. The guiding grooves 137 extend along the contacting direction D and are perpendicular to the longitudinal direction L of the positioning face 115. From FIG. 7 also visible is the insertion stop 131 positioned on each closed end 153 of each positioning face 115 of each actuating unit 105. The insertion stop 131 has a platelike shape and extends beyond the positioning face 115 in contacting direction D perpendicular to the longitudinal direction L.

Also visible from FIG. 7 is the curved shape of the positioning face 115 replicating the curvature of the circular conductors 201 in order to precisely position the conductor 201 in the insertion position IP.

According to an embodiment, the actuating unit 105 is made of plastic material.

FIG. 8 shows a schematic sectional view of the housing 101 of the electrical terminal 100 according to an embodiment.

FIG. 8 shows a sectional view along the longitudinal direction L of the housing 101. Illustrated from FIG. 8 is the accommodation space 117 defined in the inside of the housing 101 with the contacting base 103 comprising the contacting body 107 and the two blade-structures 109 positioned in the accommodation space 117. The snap connection 127 to fixate the contacting base 103 inside the accommodation space 117 is built at the inner side walls 157 of the housing 101.

Further, adjacent to an actuating opening 159, in which the actuating unit 105 can be positioned, multiple snap in protrusions 149 are formed. The snap in protrusions 149 are arranged to snap into the snap in grooves 135 of the actuating units 105 in order to lock the actuating units 105 in either the neutral position NP or the contacting position CP and to realize the snap connection 127 between the housing 101 and the actuating unit 105.

Deviating from the shown embodiment, the snap in protrusions 149 can also be formed on the actuating units 105 and the snap in grooves 135 can be respectively formed in the housing 101 in order to realize the snap connection 127 between the housing 101 and the actuating units 105.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Electrical terminal comprising:
a housing,
a contacting base positioned inside the housing, wherein the contacting base comprises a contacting body with at least one blade-structure comprising at least one blade with at least one cutting edge, and
at least one actuating unit, wherein the actuating unit is movable inside the housing along a contacting direction between a neutral position and a contacting position defined by a position of the blade-structure, wherein the actuating unit comprises a positioning face facing the blade-structure,
wherein the housing defines an accommodation space between the positioning face of the actuating unit and the blade-structure of the contacting base, and
wherein, by moving the actuating unit from the neutral position to the contacting position, a distance between the positioning face and the blade-structure is reducible.

2. Terminal according to claim 1, wherein the blade-structure comprises a forklike structure with two blades and an opening facing the positioning face of the actuating unit, wherein each of the blades has a cutting edge, and wherein the cutting edges of the two blades are facing each other and/or are facing the positioning face of the actuating unit.

3. Terminal according to claim 2, wherein the two blades of the blade-structure are spaced apart from each other and are arranged to provide a clamping force.

4. Terminal according to claim 1, wherein a tip portion of the blade has a chamfered face.

5. Terminal according to claim 1, wherein the terminal comprises two actuating units, and wherein the contacting base comprises two blade-structures connected to each other by means of the contacting body.

6. Terminal according to claim 1, wherein the contacting base has a platelike shape with the two blade-structures positioned on opposing ends of the contacting body.

7. Terminal according to claim 1, wherein the actuating unit comprises an actuating member protruding from the housing, and wherein by means of the actuating member the actuating unit can be pushed from the neutral position to the contacting position.

8. Terminal according to claim 1, wherein the actuating unit is made of a plastic material, and/or wherein the contacting base comprising the blade-structure is made of a metal material by means of a punching process and bending process.

9. Terminal according to claim 1, wherein the actuating unit is lockable in the neutral position and/or the contacting position by means of a snap connection between the actuating unit and the housing.

10. Terminal according to claim 1, wherein the housing comprises at least one insertion opening, wherein the insertion opening is elongated along the contacting direction.

11. Terminal according to claim 1, wherein the actuating unit comprises an insertion stop arranged to terminate the positioning face at a closed end opposite to the insertion opening.

12. Terminal according to claim 1, wherein the contacting base is positioned in the housing by means of a clip connection.

13. Terminal system comprising:
an electrical terminal including a housing, a contacting base positioned inside the housing, and at least one actuating unit, wherein the contacting base comprises a contacting body with at least one blade-structure comprising at least one blade with at least one cutting edge, wherein the actuating unit is movable inside the housing along a contacting direction between a neutral position and a contacting position defined by a position of the blade-structure, wherein the actuating unit comprises a positioning face facing the blade-structure, wherein the housing defines an accommodation space between the positioning face of the actuating unit and the blade-structure of the contacting base, and wherein, by moving the actuating unit from the neutral position to the contacting position, a distance between the positioning face and the blade-structure is reducible; and
at least one conductor, wherein the at least one conductor is inserted into the housing and positioned in the contacting position, wherein the actuating unit is positioned in the contacting position, wherein the conductor insulation of the conductor is cut and the conductor body of the conductor is contacted by the at least one cutting edge of the at least one edge of the blade-structure of the contacting base, and wherein an electrical contact between the conductor body of the conductor and the contacting base is provided by means of the at least one blade of the blade-structure.

14. Terminal system according to claim 13, wherein a further conductor is inserted into the housing of the terminal and positioned in the contacting position, wherein the further actuating unit is positioned in the contacting position, wherein the insulation of the further conductor is cut and the conductor body of the further conductor is contacted by the at least one cutting edge of the at least one blade of the further blade-structure of the contacting base, wherein an electrical contact between the conductor body of the further conductor and the contacting base is provided by means of the at least one blade of the blade-structure of the further blade-structure, and wherein an electrical contact between the conductor and the further conductor is provided by means of the contacting base.

15. Method of assembling a terminal system, comprising:
providing an electrical terminal including a housing, a contacting base positioned inside the housing, and at least one actuating unit, wherein the contacting base comprises a contacting body with at least one blade-structure comprising at least one blade with at least one cutting edge, wherein the actuating unit is movable inside the housing along a contacting direction between a neutral position and a contacting position defined by a position of the blade-structure, wherein the actuating unit comprises a positioning face facing the blade-structure, wherein the housing defines an accommodation space between the positioning face of the actuating unit and the blade-structure of the contacting base, and wherein, by moving the actuating unit from the neutral position to the contacting position, a distance between the positioning face and the blade-structure is reducible;
providing at least one conductor;
positioning the at least one actuating unit of the terminal in the neutral position;
inserting the at least one conductor into the housing of the electric terminal and positioning an end portion of the conductor in the insertion position; and
pushing the at least one actuating unit from the neutral position to the contacting position, wherein in the contacting position the insulation of the conductor is cut by the at least one cutting edge of the at least one blade of the blade-structure of the contacting base and the conductor body of the at least one conductor is contacted by the cutting edge of the blade of the blade-structure.
